(19) United States
(12) Patent Application Publication
(10) Pub. No.: US 2020/0330188 A1
(43) Pub. Date: Oct. 22, 2020

(54) TOOL FOR OPENING SELF-LIGATING BRACKETS

(71) Applicant: 3M INNOVATIVE PROPERTIES COMPANY, St. Paul, MN (US)

(72) Inventors: William E. Wyllie, II, Woodbury, MN (US); Kevin G. Nordine, Minneapolis, MN (US); Ming-Lai Lai, Afton, MN (US); Stephen R. Alexander, Stillwater, MN (US); Kristen F. Keller, Costa Mesa, CA (US)

(21) Appl. No.: 16/957,320

(22) PCT Filed: Dec. 12, 2018
(86) PCT No.: PCT/IB2018/060201

§ 371 Date: Jun. 23, 2020

Related U.S. Application Data
(60) Provisional application No. 62/743,118, filed on Oct. 9, 2018.
(60) Provisional application No. 62/624,329, filed on Jan. 31, 2018.
(60) Provisional application No. 62/610,791, filed on Dec. 27, 2017.

(51) Int. Cl. A61C 7/02; C04B 35/488

(52) U.S. Cl. CPC A61C 7/026; C04B 2235/3246; C04B 2235/3217; C04B 35/4885

(57) ABSTRACT

A twisting-action, sliding bracket-door opening tool including a ceramic blade for opening self-ligating brackets, particularly ceramic self-ligating brackets with ceramic doors. The ceramic tool blade allows for opening of the ceramic bracket sliding door without significant wear or function loss, as compared to a similar tool made of stainless steel.

### BACKGROUND

Orthodontic brackets may be used to align teeth by engaging an archwire, which in turn provides alignment guidance and forces. Typically, the archwire is placed in a wire slot of the orthodontic bracket that is configured to receive it. For some systems, the bracket and the archwire may be attached to each other by means of ligatures, such as, for example, rubber o-rings, or soft-steel ligatures. For other systems, the bracket and the archwire may be attached by means of a self-ligating mechanism, such mechanism eliminating the need for external ligatures.

Self-ligating orthodontic brackets with sliding door mechanisms retain the archwire by pushing the bracket door closed over the archwire after the archwire is placed in the wire slot of the bracket. The bracket door may be subsequently opened by pulling the door along its sliding track or by twisting a lever in the gap between the bracket door and the bracket body.

### SUMMARY

In one aspect, provided is a tool for opening a self-ligating orthodontic bracket, the tool comprising a blade, where the blade comprises a ceramic material. In some embodiments, the ceramic material is selected from the group consisting of a zirconia, an alumina, an alumina oxynitride, a silicon dioxide, a silicon carbide, a silicon nitride, a boron carbide, a boron nitride, diamond, and combinations thereof. In some embodiments, the tool may further comprise a handle. In some embodiments, the handle may further comprise a closing lever.

In another aspect, provided is a method for opening a self-ligating orthodontic bracket, the method comprising inserting the blade tip of a tool of the present disclosure into a space between the door and tiewing of the orthodontic bracket, and rotating the blade tip.

Features and advantages of the present disclosure will be further understood upon consideration of the detailed description as well as the appended claims.

### BRIEF DESCRIPTION OF THE DRAWINGS

FIG. 1 is a perspective view of a first embodiment of a bracket-opening tool for opening a self-ligating bracket of the present disclosure.

FIG. 2 is a perspective view of the blade of the bracket-opening tool of FIG. 1.

FIG. 3 is a perspective view of a second embodiment of a bracket-opening tool for opening a self-ligating bracket of the present disclosure.

FIG. 4 is an exploded view of the bracket-opening tool of FIG. 3.

FIG. 5 is a perspective view of the blade and a portion of the handle of the bracket-opening tool of FIGS. 3 and 4.

FIG. 5a is a perspective view of the blade of FIGS. 3-5.

FIG. 5b is a top plan view of the blade of FIG. 5a.

FIG. 5c is a side plan view of the blade of FIG. 5a.

FIG. 5d is section A-A of FIG. 5c.

FIG. 5e is a section B-B of FIG. 5c.

FIG. 5f is a perspective view of a blade including a blade tip having a recess, the blade tip engaging an archwire.

FIG. 5g is a perspective view of a blade including a blade tip having a recess.

FIG. 6 shows a hardened, stainless-steel bracket-opening tool being used to open a ceramic self-ligating bracket including a sliding door mechanism.

FIG. 7 shows the sides and tip of the blade of a stainless-steel bracket-opening tool before any opening cycles.

FIG. 8 shows the sides and tip of the blade of a stainless-steel bracket-opening tool after 1,024 opening cycles.

FIG. 9 shows the sides and tip of the blade of a zirconia bracket-opening tool before any opening cycles.

FIG. 10 shows the sides and tip of the blade of a zirconia bracket-opening tool after 1,024 opening cycles.

FIG. 11 shows the sides and tip of the blade of a zirconia bracket-opening tool after 8,192 opening cycles.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DETAILED DESCRIPTION

Provided is a twisting-action, sliding bracket-door opening tool including a ceramic blade for opening self-ligating brackets, particularly ceramic brackets with ceramic doors. The ceramic tool blade allows for opening of the ceramic bracket sliding door without significant wear or function loss, as compared to a similar tool made of stainless steel. Unlike stainless-steel tools, ceramic tool blades of the present disclosure do not leave grey/black marks on ceramic bracket doors and bodies, thus improving aesthetics of the ceramic bracket for the patient.

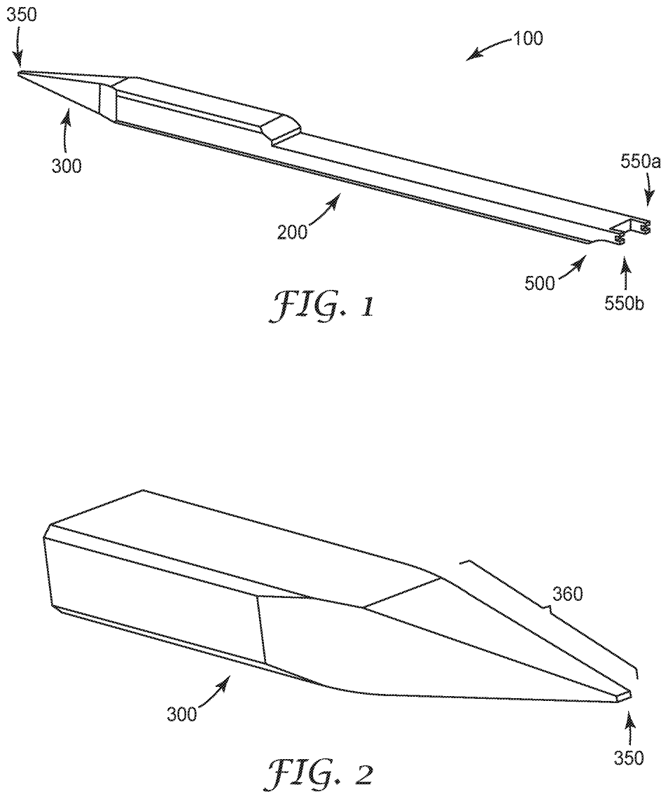

FIGS. 1 and 2 show one embodiment of a bracket-door opening tool 100 of the present disclosure. In some embodiments, the bracket-door opening tool 100 may be made entirely of wear-resistant material, such as, for example, a ceramic material. In some embodiments, the ceramic material may include dental-grade zirconia, such as that available from 3M Company, St. Paul, Minn., under tradenames LAVA Classic and LAVA Plus; from SPT Roth Ltd, Lyss, Switzerland, under tradenames Z and ZBL; from Tosoh Corporation, Tokyo, Japan, under tradenames TZ-3Y-E and TZ-3YB-E; or from CeramTec GmbH, Plochingen, Germany, under tradenames 3Y-TZP and “Zirconium Oxide Standard”. Some embodiments may include compounds with increasing amounts of alumina (e.g., ZrO₂-3Y—20% Al₂O₃), commonly known as “alumina-toughened zirconia,” available from SPT Roth AG, Lyss, Switzerland, under tradenames ZF and AZO; from Tosoh Corporation, Tokyo, Japan, under tradenames TZ-3Y20A and TZ-3Y20AB; or from CeramTec GmbH, Plochingen, Germany under the tradename ATZ. Some embodiments may include compounds with zirconia added to alumina, commonly known as “zirconia-toughened alumina,” available from SPT Roth AG under tradenames AZ, CT; and from CeramTec under tradenames 950 ZTA and 977 ZTA. In some embodiments, the ceramic material may be selected from the group consisting of a zirconia, an alumina, an alumina-toughened zirconia, a zirconia-toughened alumina, and combinations thereof.

In some embodiments, the bracket-door opening tool 100 may be machined and sintered by methods known in the art. Sintering of zirconia ceramics may be done, for example, by traditional thermal heating in a resistance furnace, by microwave heating, by spark-plasma heating, with heating and the application of pressure, such as in a hot press or hot isostatic press, or by a combination of heating and pressure modes.

Sintering generally can involve the following sequence of events: 1) a drying step, followed by 2) a heating step at a defined rate or rates of temperature increase until a maximum temperature is achieved, followed by 3) a dwell time at the maximum temperature, followed by 4) a cooling step at a defined rate or rates of temperature decrease until a minimum desired temperature is achieved.

In some embodiments, the drying step 1) may occur at room temperatures of about 20° C. to about 25° C. (e.g., 23° C.), though higher or lower temperatures may be sufficient. After drying and before heating, the object to be sintered may be placed on sintering beads to facilitate uniform shrinkage.

The heating step 2) may typically involve rates of heating from 5° C./minute to 200° C./minute (e.g., 60° C./minute). The heating step 2) may involve a single rate of heating (e.g., 30° C./minute) to achieve a maximum temperature, or more than one rate of heating, such as, for example, an initial heating rate of 20° C./minute to a first temperature, followed by heating rate of 10° C./minute to a second temperature higher than the first temperature, or an initial heating rate of 40° C./minute to a first temperature, followed by a second heating rate of 20° C./minute to a second temperature higher than the first temperature, followed by a heating rate of 15° C./minute to a third temperature higher than the second temperature. Other possible heating rates and combinations of heating rates are also contemplated.

When the maximum sintering temperature such as, for example, 1400° C., 1425° C., 1450° C., 1475° C., 1500° C., 1525° C., or 1550° C. has been achieved, step 3) may desirably be a dwell time of at least 5 minutes, at least 10 minutes, at least 20 minutes, at least 30 minutes, at least 40 minutes, at least 50 minutes, at least 60 minutes, at least 90 minutes, at least 120 minutes, at least 150 minutes, or at least 180 minutes at the maximum sintering temperature. In some embodiments, the maximum sintering temperature is about 1400° C. to about 1550° C. (e.g., 1450° C.). In some embodiments, the maximum sintering temperature may be less than or equal to 1550° C., less than or equal to 1525° C., less than or equal to 1500° C., less than or equal to 1475° C., less than or equal to 1450° C., less than or equal to 1425° C., or less than or equal to 1400° C. In some embodiments, the maximum sintering temperature may be greater than or equal to 1400° C., greater than or equal to 1425° C., greater than or equal to 1450° C., greater than or equal to 1475° C., greater than or equal to 1500° C., greater than or equal to 1525° C., or greater than or equal to 1550° C. In some embodiments, the maximum sintering temperature may be 1400° C. to 1500° C., 1420° C. to 1580° C., or 1440° C. to 1460° C. (e.g., 1450° C.)

The cooling step 4) may typically involve rates of cooling from 5° C./minute to 60° C./minute. The cooling step 4) may involve a single rate of cooling (e.g., 15° C./minute) to achieve a minimum desired temperature (e.g., 250° C., 300° C., 400° C.) or more than one rate of cooling, such as, for example, an initial cooling rate of 15° C./minute to a first temperature (e.g., 800° C.), followed by a cooling rate of 20° C./minute to a second temperature lower than the first temperature (e.g., 250° C.), or an initial cooling rate of 15° C./minute to a first temperature (e.g., 1000° C.), followed by a second cooling rate of 60° C./minute to a second temperature lower than the first temperature (e.g., 400° C.). Other possible cooling rates and combinations of cooling rates are also contemplated. Once the minimum desired temperature has been achieved, the sintered bracket-door opening tool 100 may be allowed to cool to room temperature in an unpowered furnace so as to avoid thermal shock and/or cracking.

In some embodiments, the bracket-door opening tool may be made by powder injection molding and sintering using methods known in the art. Injection-moldable ceramic materials useful in embodiments of the present disclosure are commercially available, such as, for example ZrO₂-3Y, available from SPT Roth AG, Lyss, Switzerland under tradenames Z and ZBL; from Tosoh Corporation, Tokyo, Japan, under tradenames TZ-3YS-E, TZ-3YSB-E, and TZ-3YSB-C. In some embodiments, useful ceramic materials can include those with increasing amounts of alumina (e.g., ZrO₂-3Y—20% Al₂O₃), known as “alumina-toughened zirconia,” available from SPT Roth AG, Lyss, Switzerland under tradenames ZF and AZO; or from Tosoh Corporation, Tokyo, Japan under tradenames TZ-3YS20A and TZ-3YS20AB. In some embodiments, useful ceramic materials can include those with zirconia added to alumina, also known as “zirconia-toughened alumina,” available from SPT Roth AG, Lyss, Switzerland under tradenames AZ and CT. In some embodiments, pure alumina, such as that available from SPT

Roth AG under the tradename C, may be used. In some embodiments, the ceramic material may be selected from the group consisting of a zirconia, an alumina, an alumina-toughened zirconia, a zirconia-toughened alumina, and combinations thereof.

In addition to the materials described above, other hard ceramics may be useful in embodiments of the present disclosure, such as, for example, an alumina oxynitride, a silicon dioxide, a silicon carbide, a silicon nitride, a boron carbide, a boron nitride, diamond, and combinations thereof.

In some embodiments, the blade 300 may be made of a core material, such as, for example, a stainless steel, that is fully coated or partially coated with a ceramic material, such as those described above, using techniques known in the art.

Other materials with high hardness and wear resistance may be used to fabricate the bracket-door opening tool 100, such as, for example, “machine tool” sintered carbides, including, for example, tungsten carbides, tungsten nitrides, tantalum carbides, tantalum nitrides, and combinations thereof. However, while these materials have improved wear resistance over hardened stainless steels, the ceramic materials have the advantage over both stainless steels and machine tool materials in that they do not leave grey/black marks after use on the ceramic brackets.

In one embodiment, and as shown if FIGS. 1 and 2, the bracket-door opening tool 100 can include a handle 200 and a blade 300. In some embodiments, the handle 200 and blade 300 may be formed as a single unit by, for example, machining, molding, and combinations thereof.

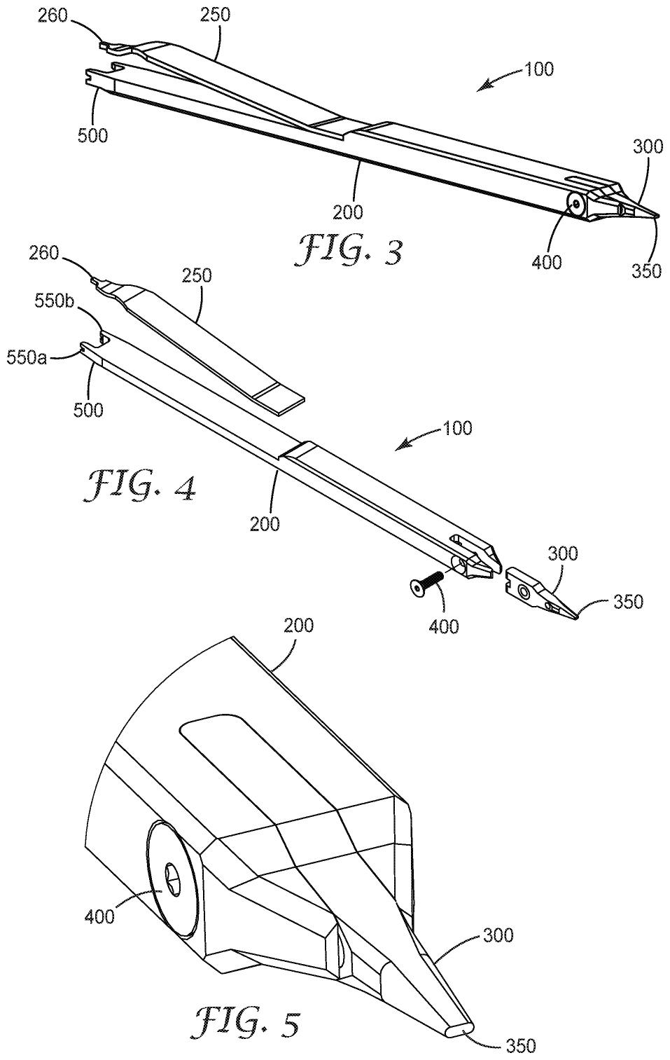

In another embodiment, and as shown in FIGS. 3-5, the handle 200 and blade 300 may be separately formed and then joined by methods known to those of ordinary skill in the relevant arts. In some embodiments, the handle 200 and blade 300 may be joined with a connector 400, which may be a screw, as shown, or another type of connector 400 such as, for example, a peg, a pin, or a bolt. In some embodiments, the handle 200 and blade 300 may be joined by crimping, welding, soldering, brazing, taping, gluing, cementing, and combinations thereof.

In some embodiments, the handle may further include a closing lever 250. Referring to FIGS. 3 and 4, when closing lever 250 is squeezed toward handle 200 in combination with closing end 500, it can be used to close a bracket sliding door over an archwire in a bracket wire slot. The wire features 550a, 550b can be used to engage the archwire on the sides of the bracket and seat the archwire into the bracket wire slot, enabling closing lever tip 260 to push the back of the bracket door closed over the archwire.

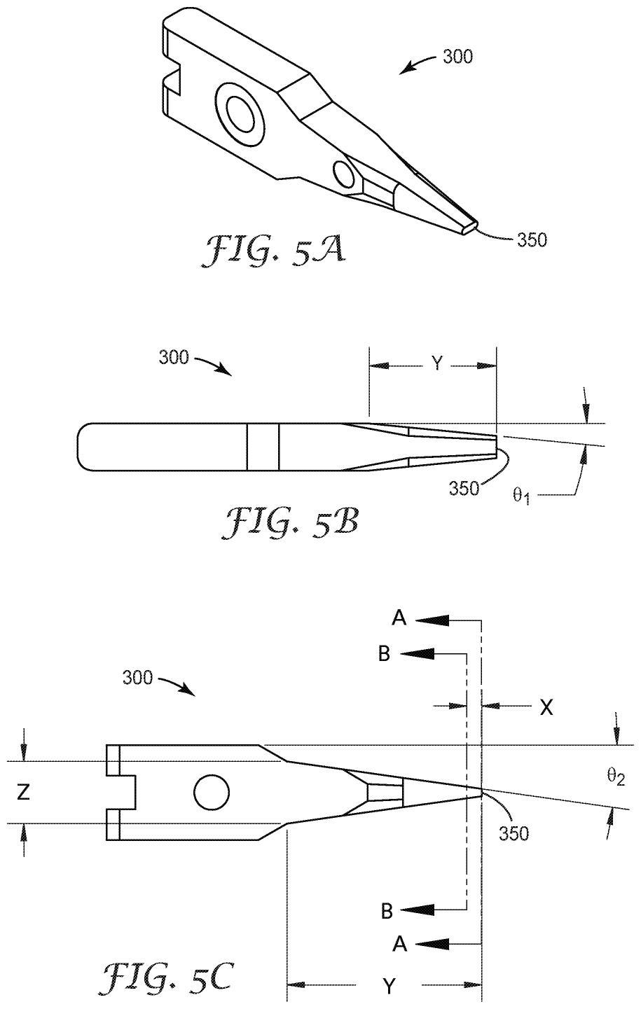

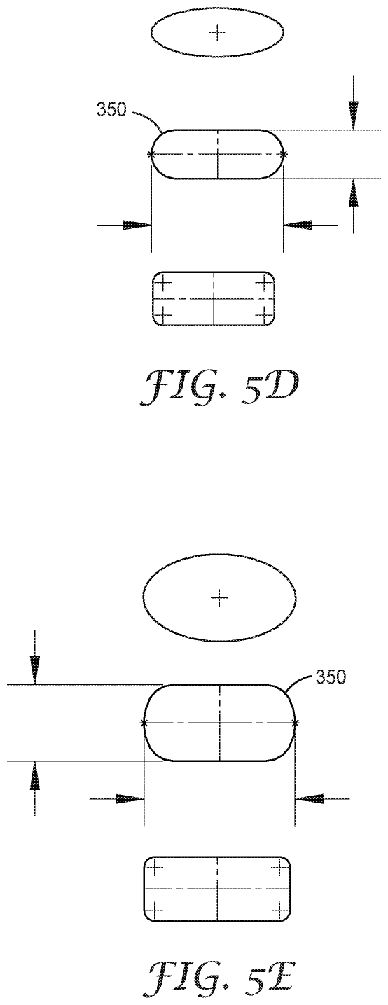

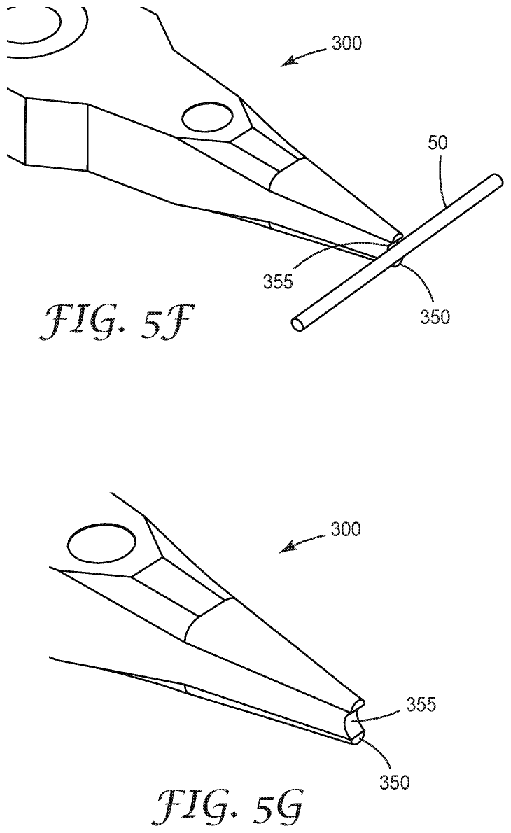

The blade 300 may have a cross-sectional profile that is, for example, square, rectangular, trapezoidal, triangular, circular, oval, elliptical, or “racetrack shaped”. As used herein, the terms “racetrack shaped” or “racetrack shape” refer to a cross-sectional profile that has elements of an ellipse and a rectangle (see FIGS. 5d and 5e, center image). In some embodiments, and as shown in FIGS. 1-5, the blade 300 may desirably taper, i.e., one or more cross-sectional dimensions decrease as the blade 300 extends away from the handle 200 and toward the blade tip 350. A view of one embodiment of the blade 300 separated from the handle 200 is shown in FIG. 5a. FIG. 5b, a top plan view of FIG. 5a, shows one aspect of the blade 300 taper, angle θ₁. In some embodiments, θ₁ may be 4° to 8°, 4.5° to 7.5°, 5° to 7°, or 5.5° to 6.5° (e.g., 6°). FIG. 5c, a side plan view of FIG. 5a, shows another aspect of the blade 300 taper, θ₂. In some embodiments, θ₂ may be 6° to 10°, 5.5° to 9.5°, 6° to 9°, or 6.5° to 8.5° (e.g., 8°). In one embodiment, angle θ₁ is 6° and angle θ2 is 8°. In one embodiment, as shown in FIG. 5b, dimension “Y” is 5.35 mm and θ₁ is 6°. In one embodiment, as shown in FIG. 5c, dimension “Y” may be 9.41 mm and θ₁ may be 6°. FIG. 5d is section A-A of FIG. 5c, and corresponds to the outer face of the blade tip 350. Referring to FIG. 5d, the profile of the blade tip 350 (center) has a shape between that of an ellipse (top) and a rectangle with rounded edges (bottom), i.e., racetrack shape. In some embodiments, the width of the blade tip 350 may be about 0.8 mm to about 1.1 mm, about 0.85 mm to about 1.05 mm, or about 0.9 mm to about 1.0 mm (e.g., 0.97 mm) and the height of the blade tip 350 may be about 0.2 mm to about 0.5 mm, about 0.25 mm to about 0.45 mm, or about 0.3 mm to about 0.4 mm (e.g., 0.36 mm). In some embodiments, the ratio of height:width at the blade tip 350 may be about 0.355 to about 0.385, about 0.36 to about 0.38, or about 0.365 to about 0.375 (e.g., 0.370). FIG. 5e is a section B-B of FIG. 5c at a distance “X” (e.g., 0.7188 mm) from the blade tip 350. Referring to FIG. 5e, the profile of the blade 300 at B-B (center) has a shape between that of an ellipse (top) and a rectangle with rounded edges (bottom), i.e., racetrack shape. In preferred embodiments, the ratio of height:width of section B-B is greater than that of that ratio of height:width at the blade tip 350 and may be, for example, about 0.49 to about 0.52, about 0.495 to about 0.515, or about 0.5 to about 0.51 (e.g., 0.507).

In some embodiments and as shown in FIGS. 5f and 5g, the blade tip 350 may include a recess 355, the recess 355 configured to engage with an archwire 50. The recess 355 shown in FIG. 5f is configured to engage with archwire 50 having a curved outer surface, though other archwire geometries, e.g., rectangular, and corresponding complementary recesses 355 are contemplated.

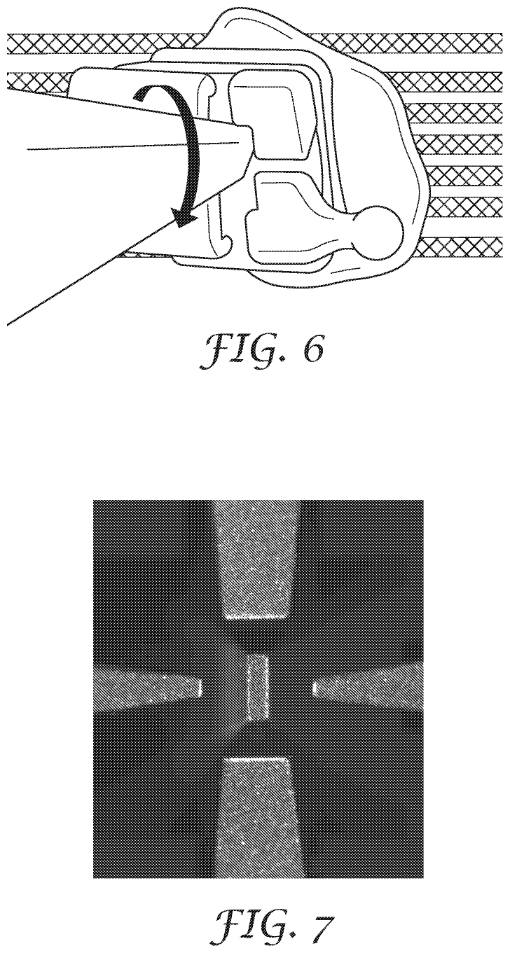

As shown in FIG. 6, the blade tip 350 is configured to fit into a space or pocket between the door and tiewing of an orthodontic bracket such that when the blade 300 is rotated, the bracket door opens.

In some embodiments, the blade 300 can be made of a ceramic material or a ceramic-coated material and attached to handle 200 made of a different material, such as, for example, a stainless steel, a titanium alloy, a plastic (e.g., a nylon, a polyethylene, polyester), a fiber-reinforced composite material (e.g., a fiber-reinforced polymer, a glass fiber-reinforced polyester, a carbon fiber-reinforced carbon composite), and combinations thereof.

In some embodiments, only a portion of the blade 300, such as, for example, the tip 350 and the region adjacent to the tip 360, i.e., the regions of the blade 300 that might come into contact with a portion of the bracket during use of the tool 100, may be made of a ceramic material or a ceramic-coated material, whereas the remainder of the tool 100 may be made of a different material, such as, for example, a stainless steel, a titanium alloy, a plastic (e.g., a nylon, a polyethylene, polyester), a fiber-reinforced composite material (e.g., a fiber-reinforced polymer, a glass fiber-reinforced polyester, a carbon fiber-reinforced carbon composite), and combinations thereof. In some embodiments, only a portion of the handle 200, such as, for example, the closing end 500 including wire features 550a, 550b and/or the closing lever tip 260, i.e., the regions of the handle 200 that might come into contact with a portion of the bracket during use of the tool 100, may be made of a ceramic material or a ceramic-coated material, such as those described above, whereas the remainder of the handle 200 may be made of a different material, such as, for example, a stainless steel, a titanium alloy, a plastic (e.g., a nylon, a polyethylene, polyester), a fiber-reinforced composite material (e.g., a fiber-reinforced polymer, a glass fiber-reinforced polyester, a carbon fiber-reinforced carbon composite), and combinations thereof.

In some embodiments, a blade 300 prepared according to the present disclosure may retain its twist function, i.e., effective opening of an orthodontic bracket door, for at least 500 cycles, at least 1,000 cycles, at least 2,000 cycles, at least 3,000 cycles, at least 4,000 cycles, at least 5,000 cycles, at least 6,000 cycles, at least 7,000 cycles, or at least 8,000 cycles, where one “cycle” is one twist opening of a self-ligating ceramic bracket door.

### SELECT EMBODIMENTS

Objects and advantages of this disclosure are further illustrated by the following non-limiting examples, but the particular materials and amounts thereof recited in these examples, as well as other conditions and details, should not be construed to unduly limit this disclosure.

A. A tool for opening a self-ligating orthodontic bracket, the tool comprising:
a blade, the blade comprising a blade tip,

wherein the blade comprises a ceramic material.

B. The tool of embodiment A, wherein the ceramic material is selected from the group consisting of a zirconia, an alumina, an alumina oxynitride, a silicon dioxide, a silicon carbide, a silicon nitride, a boron carbide, a boron nitride, diamond, and combinations thereof.
C. The tool of embodiment B, wherein the ceramic material is selected from the group consisting of a zirconia, an alumina, and combinations thereof.
D. The tool of embodiment C, wherein the ceramic material comprises ZrO₂-3Y.
E. The tool of embodiment C, wherein the ceramic material comprises ZrO₂-3Y-20% Al₂O₃.
F. The tool of any one of embodiments A-E, wherein the blade has a cross-sectional profile selected from the group consisting of a square, a rectangle, a trapezoid, a triangle, a circle, an oval, an ellipse, and a racetrack shape.
G. The tool of embodiment F, wherein the blade includes a racetrack shape cross-sectional profile having a height:width ratio of about 0.355 to about 0.385, about 0.36 to about 0.38, or about 0.365 to about 0.375.
H. The tool of any one of embodiments A-G, wherein the blade tapers.
I. The tool of any one of embodiments A-H, wherein the tool further comprises a handle.
J. The tool of embodiment I, wherein the handle comprises a different material than the blade.
K. The tool of embodiment J, wherein the handle comprises a material selected from the group consisting of a stainless steel, a titanium alloy, a plastic, a fiber-reinforced composite material, and combinations thereof.
L. The tool of any one of embodiments A-K, wherein the handle further comprises a closing end including wire features.
M. The tool of embodiment L, wherein the closing end including wire features comprises a ceramic material.
N. The tool of any one of embodiments I-M, wherein the blade and the handle are joined by a connector.
O. The tool of embodiment N, wherein the connector is selected from the group consisting of a peg, a pin, and a bolt.
P. The tool of any one of embodiments I-O, wherein the handle further comprises a closing lever including a closing lever tip.
Q. The tool of embodiment P, wherein the closing lever tip comprises a ceramic material.
R. The tool of any one of embodiments A-Q, wherein the blade retains its twist function for at least 500 cycles, at least 1,000 cycles, at least 2,00 cycles, at least 3,000 cycles, at least 4,000 cycles, at least 5,00 cycles, at least 6,000 cycles, at least 7,000 cycles, or at least 8,000 cycles.
S. The tool of any one of embodiments A-R, wherein the blade is sintered at a temperature of less than or equal to 1550° C., less than or equal to 1525° C., less than or equal to 1500° C., less than or equal to 1475° C., less than or equal to 1450° C., less than or equal to 1425° C., or less than or equal to 1400° C.
T. The tool of any one of embodiments A-S, wherein the blade tip includes a recess.
U. A method of opening a door of a self-ligating orthodontic bracket including a tiewing, the method comprising:
inserting the blade tip of the tool of any one of embodiments A-T into a space between the door and the tiewing of the orthodontic bracket; and
rotating the blade tip.

### Examples

Unless otherwise noted, all parts, percentages, ratios, etc. in the Examples and the rest of the specification are by weight.

### Example 1: Stainless-Steel Bracket-Opening Tool

A stainless-steel bracket opening tool was made by machining from type 420 stainless steel (MKT Industries, Brea, Calif.) and induction-hardening to a minimum 50 Re hardness. The blade of the tool before use is shown in FIG. 7. The durability of the tool was tested by repeatedly opening the doors of several ceramic sliding door orthodontic brackets made of aluminum oxide (alumina) by powder injection molding at SPT Roth AG, Lyss, Switzerland, and assembling at 3M Oral Care, Monrovia, Calif.

The tool opened the bracket doors 1024 times before significant wear was noted, as shown in FIG. 8. Significant wear was noted when the tool did not open the bracket door fully by the twist method. The bracket doors became more difficult to open the more the tool was worn. It was further observed that the stainless-steel opening tool gradually imparted an undesirable grey/black color to the ceramic bracket where the tool came into contact with the bracket, which was increasingly noticeable as the tool became worn.

### Example 2: Ceramic Bracket-Opening Tool

A ceramic opening tool was made to the same dimensions as the stainless-steel tool disclosed in Example 1. The ceramic tool was dental zirconia (ZrO₂-3Y, or “YSZ”) machined from 3M LAVA Plus (zirconia disc, 8S-14 mm), available from 3M Oral Care, St. Paul, Minn., in the green state using a 5-axis CNC mill (Roland model DWX-51D, available from Roland DGA Corp. Irvine, Calif.), followed by sintering to full density in an air furnace according to the following schedule:

TABLE 1
Sintering Cycle for Ceramic Opening Tool

| | Temperature | Temperature | Heating/Cooling | |
|---|---|---|---|---|
| Cycle Stage | Start | End | Rate | Time |
| Drying | Room temperature | Room temperature | | 2 hours |
| Heating | Room temperature | 800° C. | 20° C./minute | 39 minutes |
| Heating | 800° C. | 1450° C. | 10° C./minute | 65 minutes |
| Dwell Time | 1450° C. | 1450° C. | — | 120 minutes |
| Cooling | 1450° C. | 800° C. | 15° C./minute | 43 minutes |
| Cooling | 800° C. | 250° C. | 20° C./minute | 28 minutes |

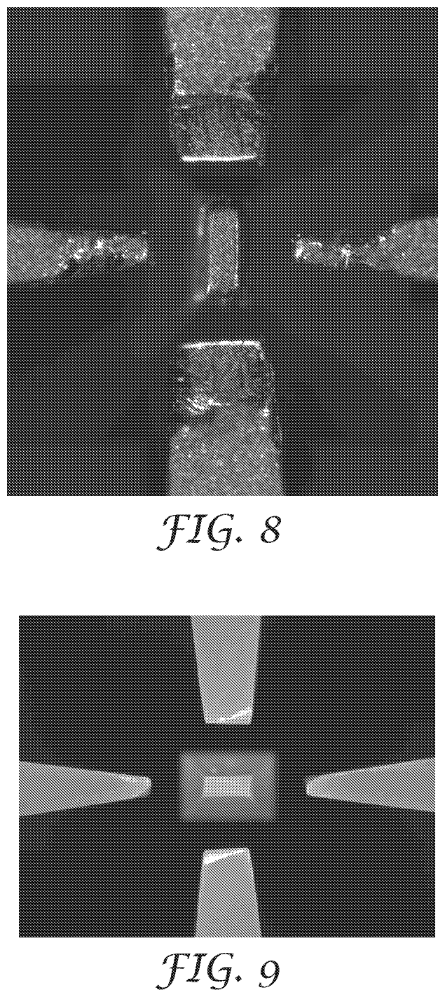

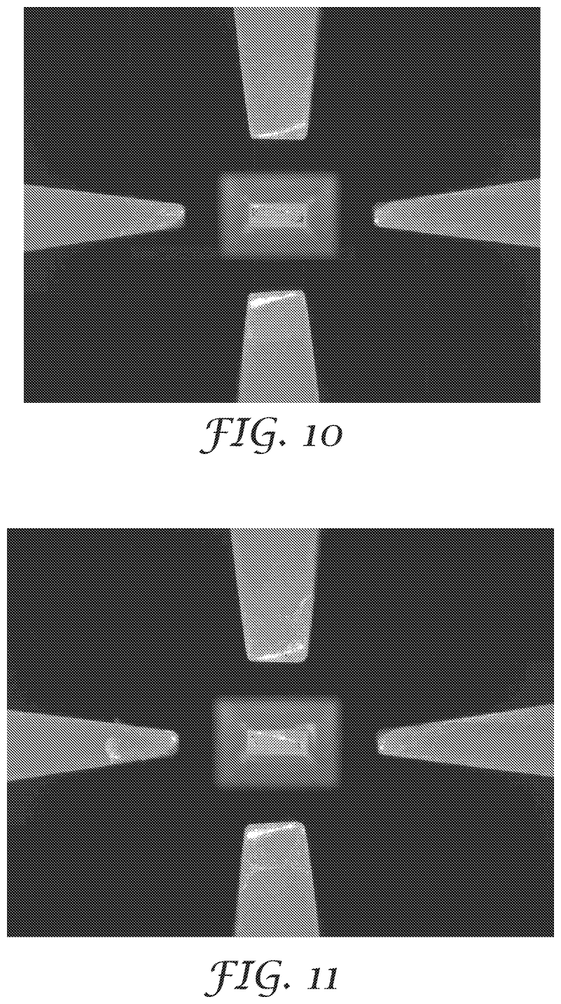

The sintered tool tip was manually polished with diamond lapping films in a stepwise manner from 30, 15, 9, and finally 3 micron diamond. The dental zirconia blade, shown in FIG. 9 before use, was tested by repeatedly opening the doors of several ceramic brackets. At the 1024 cycle point, the dental zirconia tool showed only minimal wear, as shown in FIG. 10, as compared to the steel tool. This tool opened doors 8,192 times before the significant tool wear and the twist function was impaired, as shown in FIG. 11. Surprisingly, the high strength, toughness and hardness of the dental zirconia blade is beneficial to its ability to withstand wear against the alumina bracket.

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

What is claimed is:

1. A tool for opening a self-ligating orthodontic bracket, the tool comprising:
a blade, the blade comprising a blade tip,
wherein the blade comprises a ceramic material.

2. The tool of claim 1, wherein the ceramic material is selected from the group consisting of a zirconia, an alumina, an alumina oxynitride, a silicon dioxide, a silicon carbide, a silicon nitride, a boron carbide, a boron nitride, diamond, and combinations thereof.

3. The tool of claim 2, wherein the ceramic material is selected from the group consisting of a zirconia, an alumina, and combinations thereof.

4. The tool of claim 3, wherein the ceramic material comprises ZrO₂-3Y.

5. The tool of claim 3, wherein the ceramic material comprises ZrO₂-3Y-20% Al₂O₃.

6. (canceled)

7. The tool of claim 6, wherein the blade includes a racetrack shape cross-sectional profile having a height:width ratio of about 0.355 to about 0.385, about 0.36 to about 0.38, or about 0.365 to about 0.375.

8. The tool of claim 1, wherein the blade tapers.

9. The tool of claim 1, wherein the tool further comprises a handle.

10. The tool of claim 9, wherein the handle comprises a different material than the blade.

11. The tool of claim 10, wherein the handle comprises a material selected from the group consisting of a stainless steel, a titanium alloy, a plastic, a fiber-reinforced composite material, and combinations thereof.

12. The tool of claim 1, wherein the handle further comprises a closing end including wire features.

13. The tool of claim 12, wherein the closing end including wire features comprises a ceramic material.

14. The tool of claim 8, wherein the blade and the handle are joined by a connector.

15. The tool of claim 12, wherein the connector is selected from the group consisting of a peg, a pin, and a bolt.

16. The tool of claim 9, wherein the handle further comprises a closing lever including a closing lever tip.

17. The tool of claim 16, wherein the closing lever tip comprises a ceramic material.

18. The tool of claim 1, wherein the blade retains its twist function for at least 500 cycles, at least 1,000 cycles, at least 2,00 cycles, at least 3,000 cycles, at least 4,000 cycles, at least 5,00 cycles, at least 6,000 cycles, at least 7,000 cycles, or at least 8,000 cycles.

19. The tool of claim 1, wherein the blade is sintered at a temperature of less than or equal to 1550° C., less than or equal to 1525° C., less than or equal to 1500° C., less than or equal to 1475° C., less than or equal to 1450° C., less than or equal to 1425° C., or less than or equal to 1400° C.

20. The tool of claim 1, wherein the blade tip includes a recess.

21. A method of opening a door of a self-ligating orthodontic bracket including a tiewing, the method comprising:
inserting the blade tip of the tool of claim 1 into a space between the door and the tiewing of the orthodontic bracket; and
rotating the blade tip.
